(19) United States
(12) Patent Application Publication
(10) Pub. No.: US 2011/0048292 A1
(43) Pub. Date: Mar. 3, 2011

(54) BALLISTIC PANEL

(75) Inventor: Charles F. Zimmer, II, River Ridge, LA (US)

(73) Assignee: BALLISTA INDUSTRIES, LTD., River Ridge, LA (US)

(21) Appl. No.: 12/551,873

(22) Filed: Sep. 1, 2009

(51) Int. Cl. E05G 1/026; E05G 1/024; F41H 5/24

(52) U.S. Cl. 109/64; 109/79; 89/36.01; 89/36.02; 89/920; 89/904; 89/917; 89/906; 89/914

(57) ABSTRACT

An apparatus for protecting a building opening, comprising, a first panel, having a first end and a second end, pivotably coupled to the building at the first end; at least one second panel, having a first end and a second end; a first hinge, coupled to the second end of the first panel and the first end of the at least one second panel, configured for folding the first panel parallel to the second panel; and at least one attachment means.

### CROSS-REFERENCE TO RELATED APPLICATIONS

Not Applicable.

### STATEMENT REGARDING FEDERALLY SPONSORED RESEARCH OR DEVELOPMENT

Not Applicable.

### FIELD OF THE INVENTION

This invention relates to securing a building and more specifically to protecting a building against projectiles.

### BACKGROUND OF THE INVENTION

There are several storm shutters, roll-down doors, and other various rigid and flexible structural covers designed for building integrity protection. Conventionally, a thin sheet of plywood, aluminum, rigid plastic, or other material is secured to the structure as the extent of protection. More advanced protection includes large metal roll-down doors. These structures are designed to reduce the physical effects of high wind events and related driving water. However, these structures have a high cost associated with the material, installation, and/or maintenance. Typically the limited effectiveness for the reduction of projectile, wind, and water damage and protection of structural integrity. Further, the conventional methods may significantly impair the aesthetics of the structure and are often unrecyclable, un-reusable, or otherwise wasteful with regards to material and structure.

### BRIEF SUMMARY

In one configuration according to the disclosure an apparatus for protecting a building comprises, a panel, having a first end and a second end; a hinge, coupled to the first end of the panel; and at least one attachment means.

In a further configuration according to the disclosure an apparatus for protecting a building opening, comprises, a first panel, having a first end and a second end, pivotably coupled to the building at the first end; at least one second panel, having a first end and a second end; a first hinge, coupled to the second end of the first panel and the first end of at least one second panel, configured for folding the first panel parallel to the second panel and unfolding the second panel in alignment with first panel to make a contiguous flat surface; and at least one attachment means.

Further one method of securing a building opening according to the disclosure comprises removing a retainer from a storage member, adjacent to the opening, containing at least two panels, pivotably coupled by a hinge having a reinforcement disposed behind the hinge; pivotably removing a free end of a first panel from the storage member wherein the second panel follows the first panel; extending the at least two panels, to form a planar structure covering the building opening, wherein the hinge extends to about 180 degrees; securing the at least two panels to the building opening by a reversible coupling means.

These and other configurations, features, and advantages of the disclosure will be apparent with reference to the following drawings and description.

### BRIEF DESCRIPTION OF THE DRAWINGS

FIG. 1 illustrates a front view according to one configuration of the panel system.

FIG. 2A illustrates a detail view of the hinge and reinforcement according to one extended configuration of the panel system.

FIG. 2B illustrates a cross-section view of the hinge and reinforcement according to one folded configuration of the panel system.

FIG. 3 illustrates a detail view of the hinge and reinforcement according to another extended configuration of the panel system.

FIG. 4 illustrates a detail view of a securable member according to one configuration of the panel system.

FIG. 5 illustrates a cross-section view according to one folded configuration of the panel system.

### DETAILED DESCRIPTION

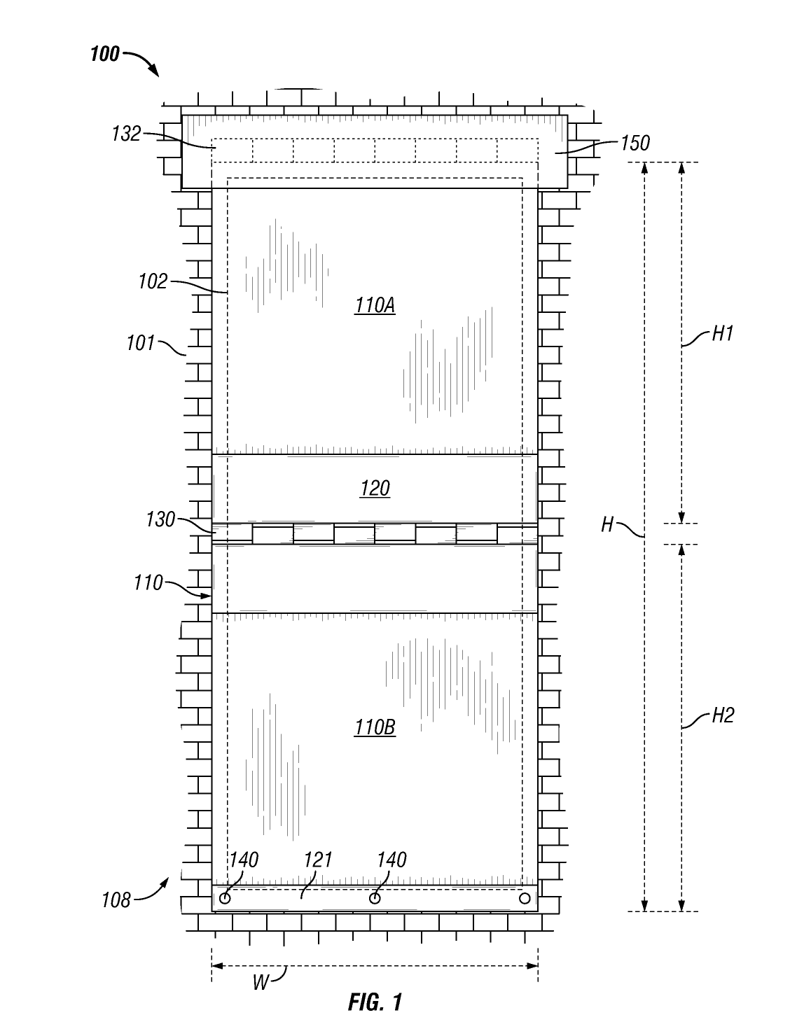

FIG. 1 illustrates a panel system 100 configured for protecting a building 101, openings 102 of a building 101, doors, or windows of a building, or other means of entering any structure. The panel system 100 comprises panel(s) 110, coupling zone(s) 120, pivotable member(s) 130, securable member(s) 140, and storage member 150. Panel system 100 comprises extended panel assembly 108 for securing openings 102 of building and folded panel assembly 109 for storage. Folded panel assembly 109 is configured for foldable storage in storage member 150 disposed adjacent to openings 102 of a building 101, doors, or windows of a building, or other means of entering any structure. Extended panel assembly 108 is configured for sever weather resistance, for instance high wind, thunderstorm, tornado, and typhoon/hurricane resistance. In certain instances, panel system 100 is configured for resistance to wind and wind-driven projectiles during severe weather. Further, panel system 100 is configured for reversibly sealing the openings 102 of a building 101, doors, or windows of a building, or other means of entering any structure, for instance to prevent theft, looting, or unauthorized residence after a sever weather event. In further applications, panel system 100 is configured for securing structure during other voluntary or involuntary absences. In further configurations, panel system 100 is configured to resist or deflect explosions and shrapnel from penetrating openings 102 of a building 102, doors, or windows of a building, or other means of entering any structure. Exemplary explosions may be vandalism, civil unrest, pranks, fireworks, pipe-bombs, improvised explosive devices, grenades, and the like, without limitation.

Panel. Panel 110 comprises a generally rigid, planar sheet of material. The material comprises a material suitable for withstanding projectile impacts; alternatively, for withstanding explosions and shrapnel. Panel 110 materials comprise a metal, an alloy, a ceramic, a polymer, a composite, a fabric, or combinations thereof. Panel 110 comprises a metal or metal alloy, such as, but not limited to, steel, aluminum, magnesium, manganese, chromium, titanium, vanadium, tungsten, and other metals understood to be impact resistant. Panel 110 comprises a ceramic such as, but not limited to, alumina, aluminum oxide, boron carbide, and silicon carbide. Panel 110 comprises a polymer, polymer fiber, polymer panel, and combinations thereof. In instances, the panel 110 comprises a polymer such as polyethylene, polystyrene, polypropylene, polyurethane or other polymer resins, poly-acrylamide, para-amids, polybenzoxaole, and the like, without limitation. Further, panel 110 comprises a phenolic-resin, such as but not limited to phenol-formaldehyde, polyoxybenzylmethylenglycolanhydride, and a base material, such as but not limited to saw-dust, paper, pulp, cotton, linen, fiberglass, carbon fiber, carbon black, and others known in the art. The material comprises a minimum strength determined by any building code, for instance, the Miami-Dade County Building Code, without limitation. Alternatively, the material may comprise any minimum strength.

In certain instances, the panel 110 comprises a reinforcement material, for instance a fabric, film, or screen. In certain instances, the reinforcement layer comprises Kevlar®, carbon fiber, nanotubes, wire mesh, polymer films, resins, or the like, without limitation. The reinforcement layer is configured to provide impact dissipation, shear strength, flexibility, and combinations thereof to the panel 110. In certain instances, the reinforcement is cast, molded, or otherwise impregnated into the matrix of panel 110. Alternatively, panel 110 comprises a reinforcing coating applied to at least one exterior face. In further instances, panel 110 comprises a plurality of layers, wherein at least one layer comprises a reinforcement layer. Without limitation by theory, the reinforcement material maintains the integrity of the panel 110 after impact. Further, the reinforcement material prevents fragmentation, shear fracture, brittle fracture, or other failure modes of the panel 110 after impact of a projectile. Reinforcement material in panel 110 prevents portions of panel 110 from becoming additional debris, projectiles, or shrapnel.

Panel 110 has a vertical dimension or height H and horizontal dimension or width W. Vertical dimension H is taller than about the vertical dimension of the openings 102 of a building 101. Horizontal dimension W is wider than about the horizontal dimension of the openings 102 of a building 101. Without wishing to be limited by theory, the panel 110 extends beyond the dimensions of any openings 102 of a building 101, such that wind, water, debris, shrapnel, and other projectiles cannot directly impact the opening 102. Further, the Panel 110 is configured to prevent ricocheted, deflected, or redirected projectiles from entering interior of building 101 through the aforementioned openings 101.

Alternatively, in multi-panel configurations, the combined dimensions of each panel, for instance H1 and H2, is taller than about the vertical dimension of the openings of a building, such as doors and windows of a building, or other means of entering any structure. In certain instances, panel system 100 comprises a plurality of panels. Multi-panel configurations provide scalable and modular means to expand panel system 100.

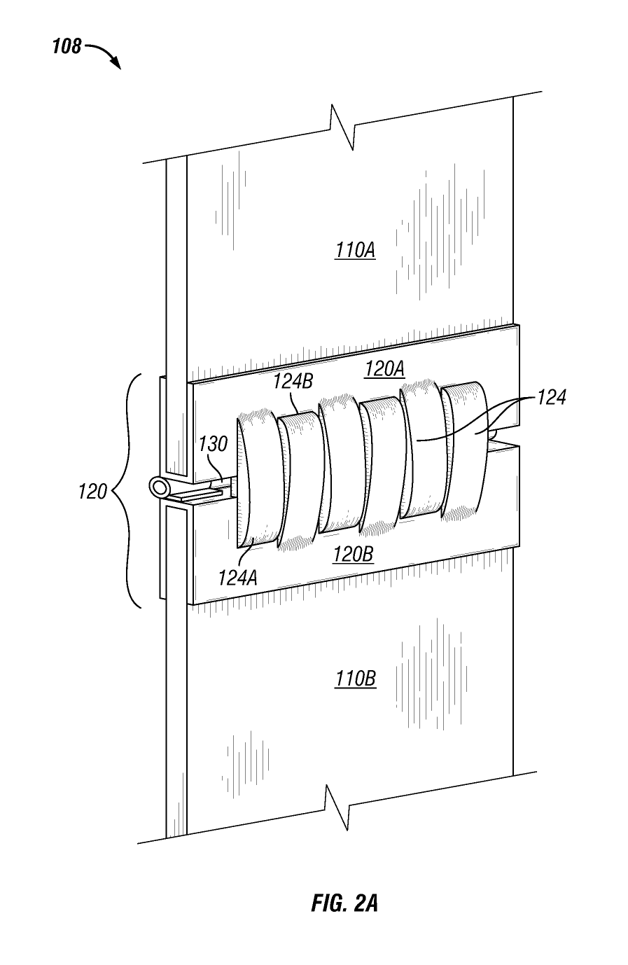

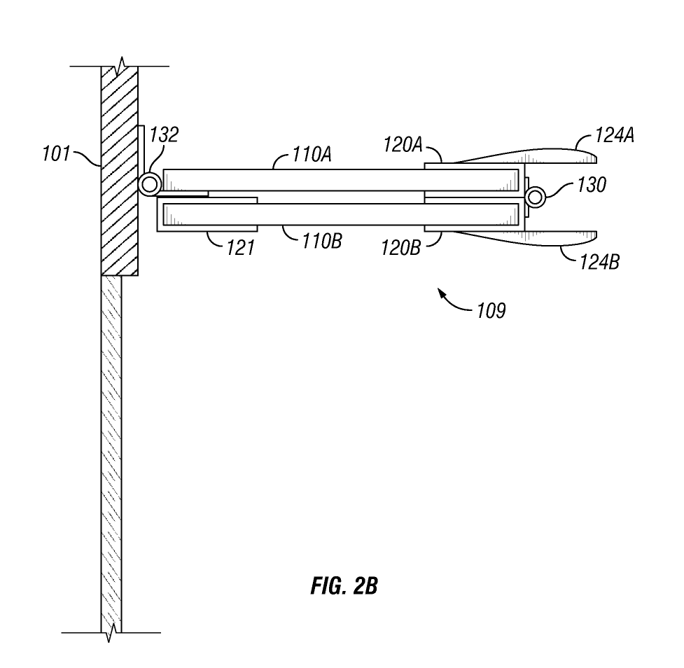

Hinge. Referring now to FIG. 2A panel system 100 comprises a hinge 130 disposed between at least two adjacent panels 110, for instance a first panel 110A and a second panel 110B. Hinge 130 comprises any pivotable apparatus configured for folding at least one generally planar apparatus, such as a door or panel 110. Hinge 130 is constructed of any material suitable for withstanding projectile impacts; alternatively, for withstanding explosions and shrapnel. Hinge 130 comprises a metal hinge; alternatively, hinge is any flexible material suitable for pivoting, rotating, of bending action. Alternate hinge 130 materials include without limitation, ballistic cloth, flexible polymers, and any flexible material configured for impact resistance. In certain instances, hinge 130 is positioned approximately half the vertical dimension H of the panel 110. Alternatively, hinge 130 is positioned any where along height H. In these configurations, first panel 110A has height H1 and second panel 110B has height H2, as illustrated in FIG. 1. In multiple panel configurations, the sum of height of all panels is equal to height H.

Hinge 130 is configured such that panel the second 110B folds up and away from the building 101 or the opening 102. Without wishing to be limited by theory, a hinge 130 configured to fold up and away from the building 101, such that panel 110 is parallel to ground. Further, hinge 130 is configured to pivot toward opening 102. Further, hinge 130 comprises a locked position when open extended over the opening 102. The locked position of hinge 130 results at least, in part, by hinge 130 reaching a 180 degree open position. In alternative, instances at a contact between first panel 110A and second panel 110B. Alternatively, hinge 130 may be positioned such that first panel 110A and second panel 110B fold in, toward the building. The panel 102 configured to fold in toward building 102 comprises a locked position when open extended over the opening 102. In certain instances, the locked position prevents flexing, bending, deforming, or otherwise compromising the panel 110 during weather event, projectile impact, or ballistic impact.

Coupling Zone. Hinge 130 is coupled to the panels 110 at a coupling zone 120. Coupling zone 120 comprises an area of panel 110 configured to resist deformation under pressure, stress, impact, sheer, or strain. Coupling zone 120 comprises a metal, an alloy, a ceramic, a polymer, a composite, a fabric, or combinations thereof, without limitation. Coupling zone 120 further comprises a coupling means between hinge 130 and panel 110. In certain instances, coupling zone 120 comprises a sleeve to fit around panel 110. Further, coupling zone comprises an additional panel fixed to panel 110 on at least one side. Alternatively, coupling zone 120 comprises an unmodified portion of panel 110 or any portion of panel 110.

Coupling zone 120 comprises fingers 124. Coupling zone 120 comprises at least one set of fingers 124. Fingers 124 comprise an extension from coupling zone 120. Fingers 124 extend from coupling zone in at least one direction. In certain instances, coupling zone 120 comprises at least two sets of fingers 124. Further, fingers 124 comprise first fingers 124A coupled to first coupling zone 120A of first panel 110A and second fingers 124B coupled to second coupling zone 120B of second panel 110B. In certain configurations fingers 124 form a reinforcement or a brace behind hinge 130, for example crossing from 120A to contact 120B, and vice versa, to resist further pivoting, rotation, impact, breakage, shearing, or flexing from the application of additional stresses on hinge. In certain instances, only the first fingers 124A are present. Alternatively, first finger 124A comprises a single panel, lip, brace, or the like disposed behind hinge 130. In certain instances, first fingers 124A and second fingers 124B comprise interlocking comb-like, teeth-like, or finger-like extensions of first coupling zone 120A and second coupling zone 120B, respectively. In instances, the interlocking fitment of first fingers 124A and second fingers form reinforcement behind hinge 130 to resist further pivoting, rotation, impact, breakage, shearing, flexing, or application additional stresses on hinge.

First finger 124A comprises a linear extension of first coupling zone 120A. In instances, first finger 124A comprises any linear protrusion from first coupling zone 120A. Alternatively, first finger 124A is reversibly attached to first coupling zone 120A to prevent flexing towards the building opening 102. In certain instances, first finger 124A is mechanically attached to the first coupling zone 120A and first panel 110A. Examples of suitable mechanical attachment includes, screws, bolts, rivets, nails, pins, glues, epoxies, and the like, without limitation. First finger 124A is disposed normal or perpendicular to hinge 130. In certain instances, first finger 124A is oriented vertically.

Second finger 124B is disposed on the opposite side of hinge 130 from first finger 124A. Second finger 124B comprises a linear extension of second coupling zone 120B. In instances, second finger 124B comprises any linear protrusion from second coupling zone 120B. Alternatively, second finger 124B is reversibly attached to second coupling zone 120B. In certain instances, second finger 124B is mechanically attached to the second coupling zone 120B and second panel 110B. Examples of suitable mechanical attachment includes, screws, bolts, rivets, nails, pins, glues, epoxies, and the like, without limitation. Second finger 124B is disposed normal or perpendicular to hinge 130. In certain instances, second finger 124B is oriented vertically.

Referring now to FIG. 2B, illustrating a side view of the folded panel assembly 109, with hinge 130 in a folded position. Hinge 130 is configured to fold away from fingers 124 at coupling zone 120. As illustrated, hinge 130 unfolds and opens flat, towards structure 102. Further, panels 110A and 110B form a generally planar structure and fingers 124A and 124B form extensions of the planar structure, resisting flexing towards structure 102. A planar structure, such as folded panel assembly 109 comprises a planar assembly store or mounts to building 101. Further, folded panel assembly 109 is configured for storage out of the line of sight of building 101 occupants. In certain configurations, folded panel assembly 109 is at least partially hidden from a passerby, pedestrian, and other people outside the building.

Alternatively, first finger 124A is coupled to hinge 130. In certain instances, first finger 124A may comprise an extension of second panel 110B. First finger 124A is disposed normal or perpendicular to hinge 130. In certain instances, first finger 124A is oriented vertically. Second finger 124B is disposed on the opposite side of hinge 130 from first finger 124A, comprising a linear extension of hinge 130. Second finger is disposed normal or perpendicular to hinge 130. First finger 124A and second finger 124B are arranged in alternating fashion along hinge 130 across the width W of panel system 100 or panel 110. First finger 124A is configured to contact first coupling zone 120A of first panel 110A. Second finger 124B is configured to contact second coupling zone 120B of second panel 110B. Without limitation by theory, the contact of fingers 124 with coupling zone 120 is configured to reduce flexing, bending, deforming, or otherwise compromising the panel 110 along hinge 130 during weather event, projectile impact, or ballistic impact. Further, fingers 124 reinforce area around hinge 130.

Fingers 124 further comprise a passage, a tube, or the like for passing a rod, a bar, a post or other member therethrough. The addition of this member further reinforces the fingers by temporarily coupling the first fingers 124A and the second fingers 124B. Without limitation by theory coupling first fingers 124A and second fingers 124B forms a monolithic or one-piece reinforcement to hinge 130.

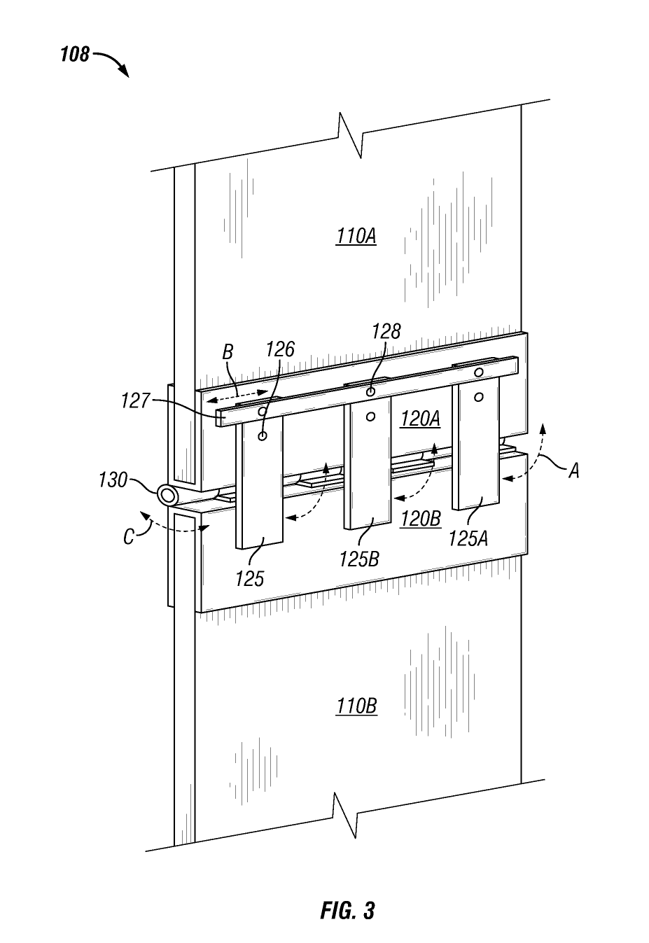

Referring to FIG. 3 in further alternate configurations, fingers 125 are slidably or pivotably disposed on panel 110, such that hinge 130 is configurable to pivot or fold in multiple directions. In certain instances, slidable fingers 125 comprise at least one pivot 126 disposed on each finger 125. In certain instances, pivot 126 is disposed proximal to the first end 125A of the finger 125. Pivot 126 comprises any means to couple finger 125 to panel 110 or coupling zone 120. Further, finger 125 is free to rotate about pivot 126 in any direction, for instance along axis of rotation A.

Finger 125 is coupled to rod 127 at attachment 128 of each finger 125. Rod 127 is transversely slidable along axis B across width W of the panel 110. Attachment 128 comprises a pivotable coupling, disposed at the first end 125A of finger 125. In certain instances, finger 125 is pivotably coupled to rod 127 such that when rod 127 moves transversely along axis b, finger rotates about pivot 126 along axis of rotation A. Without limitation by theory, the axis of rotation A is configured such that second end 125B of fingers 125 is rotated so as to allow hinge 130 to fold such that zone 120B folds vertically towards pivot 128. Further, second end 125B of fingers 125 are rotated such that they minimally impede folding of hinge 130, for example along axis C. Slidable fingers 125 are configured to allow hinge 130 to fold beyond 180° towards slidable fingers 125 in order to improve storage of the panel system 100. Panel system 100 configured to fold hinge 130 toward fingers 125, also permits additional hinges and folding positions, such as accordion style, to form folded panel assembly 109.

Mounting. Referring once more to FIG. 1, system 100 comprises a pivotable means to couple panel 110 to the building, such as mounting hinge 132. Mounting hinge 132 is configured to support the vertically hanging weight of the panel system 100, for instance as extended panel assembly 108. Alternatively, the mounting hinge 132 is configured to secure panel system to the building 101. Mounting hinge 132 is configured for positioning vertically adjacent to the opening 102 of the building 101. Mounting hinge 132 is configured to resist projectile impacts, deformation, shearing, and pull out from building. Mounting hinge 132 is constructed of any material suitable for withstanding projectile impacts; alternatively, for withstanding explosions and shrapnel. Mounting hinge 132 comprises a metal hinge; alternatively, hinge is any flexible material suitable for pivoting, rotating, of bending action. Alternate mounting hinge 132 materials include without limitation, ballistic cloth, flexible polymers, and any flexible material configured for impact resistance. Mounting hinge 132 is configured for moveably mounting the panel system 100 to the building 101. Mounting hinge 132 is configured for rotating panel into a storage member 150 or up against underside of building 102 structures, such as the eve, ceiling, portico, patio, veranda, and the like without limitation.

Securing. Panel system 100 is configured for reversible securing to building 101. Panel system 100 comprises securable member 140 disposed at the opposite side of panel 110 from mounting hinge 132. In further instances, a securable member is configurable for positioning along the perimeter of panel 110. For example, along the overlap of panel 110 and building 101. Securable member 140 is configured to couple panel 110 to building 101 and resists impacts, shear, or other forces against building 101 and opening 102. Further, securable member 140 is configured to resist unauthorized intrusion via opening 102. Without limitation by theory, extending panel system 100, as extended panel assembly 108, across opening 102 of building 101 secures building from wind, water, explosions, shrapnel and unauthorized entry by coupling free end of panel 110 to building.

In certain instances, free end of panel 110 further comprises a free coupling zone 121. Free coupling zone 121 comprises an area of panel 110 configured to resist deformation under pressure, stress, impact, sheer, or strain. Free coupling zone 121 comprises a reinforced portion of panel for mounting securable member 140. Free coupling zone 121 comprises a metal, an alloy, a ceramic, a polymer, a composite, a fabric, or combinations thereof, without limitation. Free coupling zone 121 further comprises a coupling means between panel 110 and building 101. In certain instances, free coupling zone 121 comprises a sleeve to fit around panel 110. Further, free coupling zone comprises an additional portion of panel fixed to panel 110 on at least one side. Further, free coupling zone 121 comprises a modified or reinforced portion of panel 110. Alternatively, coupling zone 120 comprises an unmodified portion of panel 110.

Securable member 140 comprises a post and lock, a rivet, a spike, a nail, a screw or any other means of mechanically coupling free coupling zone 121 to building 101. In certain instances, securable member is disposed within panel 110 at free coupling zone 121. For instance, a spike or tube protrudes into building from the free coupling zone 121. Without limitation by theory, a securable member 140 formed as part of free coupling zone 121 is configured to resist shearing, vibrating, pulling, prying, or otherwise compromising the coupling between panel 110 and building 101.

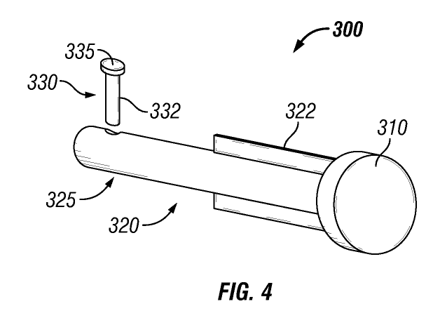

Referring now to FIG. 4 illustrating a securable member 300. Securable member 300 comprises head 310, insertion shaft 320, and locking shaft 330. Head 310 is configured for coupling with panel 110 by the free coupling zone 121 or along at overlap of panel 110 and structure 101. Head 310 is configured to have a cross-section that is wider than the insertion shaft 320. Head 310 is configured to retain panel 110 by an interference lip, flange, post, or other structure that extends beyond insertion shaft. Head 310 is configured to resist deformation under pressure, stress, impact, sheer, or strain. Head 310 comprises a metal, an alloy, a ceramic, a polymer, a composite, or combinations thereof without limitation. Head 310 comprises any material suitable for resisting corrosion and forces such as shearing, vibrating, pulling, prying, or forces otherwise directed to compromising the coupling between panel 110 and building 101. Head 310 is configured as a generally planar flange about insertion shaft 320. Without wishing to be limited by theory, maintaining a planar configuration resists prying by resisting insertion of a prying apparatus under head 310. Alternatively, head 310 comprises a dome shape such that prying tools are not able to be wedged between head 310 and panel 110. In certain instances, head 310 comprises teeth, angles, slopes, curves, or other edge structures configured to impede the insertion of a prying apparatus between the panel 110 and head 310. Further, head 310 is welded or machined as a portion of insertion shaft 320 to resist prying, shear, vibration, tensile strain, or other forces directed to removing head 310 from insertion shaft 320.

Insertion shaft 320 is configured for passing through panel 110, free coupling zone 121, and the building 101 wall. Insertion shaft 320 is a linear structure having any shape without limitation; in certain instances, insertion shaft 320 is generally cylindrical. Insertion shaft 320 comprises a solid shaft; alternatively, insertion shaft 320 is hollow. Without limitation by theory, a hollow insertion shaft 320 resists torsional shearing and failure by deformation. Alternatively, insertion shaft 320 comprises a solid shaft. Insertion shaft comprises flanges 322, and locking passage 325. In certain instances, flanges 322 are further coupled to head 310. Insertion shaft 320 and flanges 322 are configured to resist deformation under pressure, stress, impact, sheer, or strain. Insertion shaft 320 and flanges 322 comprise a metal, an alloy, a ceramic, a polymer, a composite, or combinations thereof without limitation. Insertion shaft 320 and flanges 322 comprise any material suitable for resisting forces such as shearing, vibrating, pulling, prying, or forces otherwise directed to compromising the coupling between panel 110 and building 101. Without limitation by theory, flanges 322 are configured to resist rotation of insertion shaft 320. Further, flanges 322 are configured to align insertion shaft 320 in building 101. Flanges 322 are welded or machined as a portion of insertion shaft 320 to resist prying, shear, vibration, tensile strain, or other forces to separate insertion shaft 320 and head 310.

Insertion shaft 320 further comprises coupler 325. Coupler 325 comprises a means to couple locking shaft 330. Coupler 325 a passage, a bore, a tube, a hole, or a receptor; in certain instances, coupler 325 is a threaded receptor for coupling locking shaft 330. Coupler 325 is arranged within insertion shaft 320. In certain instances, coupler 325 is positioned at a right angle to insertion shaft 320. Flanges 322 are configured to align insertion shaft 320 such that coupler 325 is accessible by locking shaft 330. Alternatively, coupler 325 is positioned in insertion shaft 320 at any angle Locking shaft 330 is configured to pass through coupler 325. Locking shaft 330 is configured for insertion into coupler 325. In certain instances, locking shaft 330 is configured to thread into the coupler 325, to form a tensile coupling. Further, locking shaft 330 positioned in coupler 325 is configured to prevent removal or pull out of the insertion shaft 320 from building 101 and panel 110.

Locking shaft 320 comprises any material suitable for resisting corrosion and forces such as shearing, vibrating, pulling, prying, or forces otherwise directed to compromising the coupling between panel 110 and building 101, or the coupling between locking shaft 330 and insertion shaft 320. Locking shaft 330 comprises a metal, an alloy, a ceramic, a polymer, a composite, or combinations thereof without limitation. Locking shaft 330 comprises linear shaft 332 and head 335. Linear shaft 332 comprises a linear rod for insertion into coupler 325. Linear shaft 332 comprises any linear shape, without limitation, for instance a cylinder. Additionally linear shaft 332 comprises threads, slots, or grooves for coupling to insertion shaft 320 and coupler 325. Insertion shaft 332 may further comprise a lockable means. Head 335 comprises a manual interface, handle, or other handheld means, without limitation.

Securable member 300 is configured for securing panel system 100 from the interior of the building 101. In certain instances, panel 110 is extended, as extended panel assembly 108, over opening 102 in preparation for a weather event, other potential situation comprising projectiles, or to secure openings of building against intrusion. Securable member 300 is inserted through panel 110, via free coupling zone 121, and/or along H1 and H2 in overlap of 110 and 101. Securable member 300 head 310 interfaces with free coupling zone 121. In certain instances, securable member 300 is inserted through coupling zone 120, in order to secure hinge 130 and panel 110 to building. Alternatively, securable member 300 may pass through any portion of panel 110 of extended panel assembly 108. Insertion shaft 320 passes into building, such that flanges 322 align coupler 325 with locking shaft 330. Locking shaft 330 is configured to retain insertion shaft 320 in position. Without limitation by theory, internal securing of panel system 100 enhances the security of the panel system, by tying the securable member 300 to the building 101 structure. In certain instances, tying or coupling panel to portions of building 101 enhances resistance to impacts by dissipating impact throughout building.

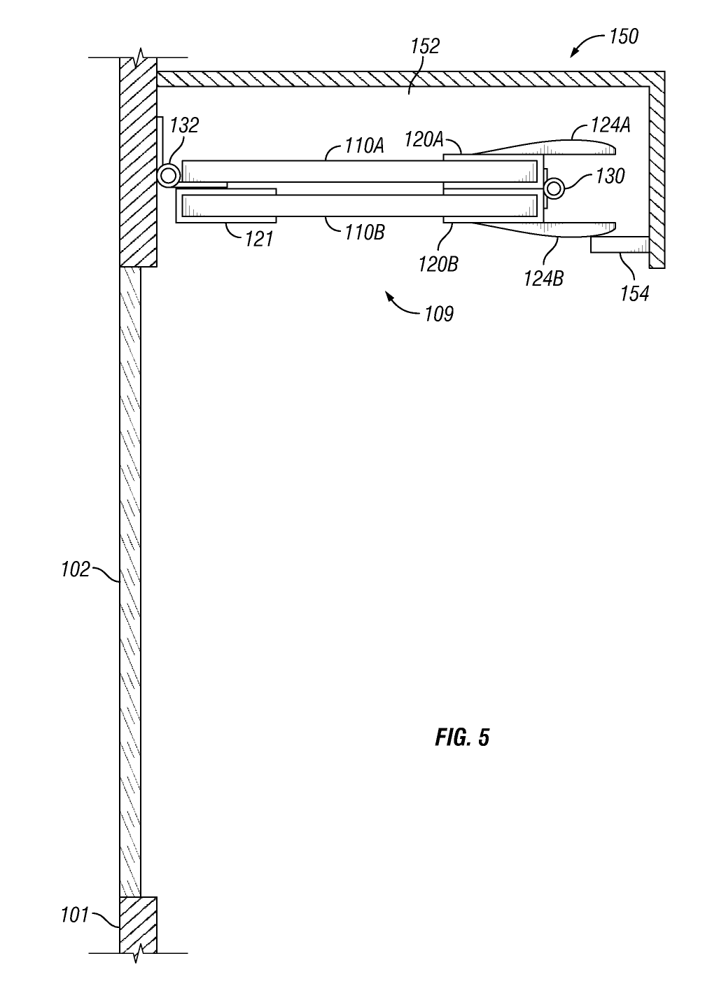

Storage. Referring now FIG. 5, storage member 150 comprises an exterior building feature, for instance a cavity or other open surface area disposed over or under or along the sides of an opening 102 of a building 101. In certain instances, storage member comprises an awning, overhang, eve, roofline, a ceiling, a veranda ceiling, a patio ceiling, or other structure without limitation. In certain instances, storage member 150 comprises a box, cavity, or locker disposed inside the façade and walls of the building 101. In certain instances, storage member 150 comprises a decorative trim, planter, or any other structure positioned in close proximity to a window, suitable for storing panel system 100, without limitation, including areas below and on the side of 102.

Storage member 150 is configured to retain panel system 100 in the folded configuration. Storage member 150 comprises compartment 152 and retaining member 154. Compartment 152 is configured to fit the folded panel assembly 101. In certain instances, first panel 110A and second panel 110B are folded such that hinge 130 and fingers 124 are positioned adjacent retaining member 154. Retaining member 154 comprises any portion of storage member 150 configured to support folded panel assembly 109. In certain instances, retaining member comprises a lock, a bar, a shaft, a spring, a hook, a loop, or an assembly, such as a gas shock, or a gas spring, without limitation. Retaining member 154 may be coupled to storage member 150 at any position; alternatively, retaining member 154 is coupled to the building 101.

Alternatively, panel system 100 may comprises a horizontal configuration. In alternate configurations, mounting hinge 132 is disposed on building 101 vertically along opening 102 to support panel 110. Mounting hinge 132 is configured to fold panel 110 horizontally across opening 102. Further, mounting hinge 132 is designed to support weight and torque of panel 110 in this configuration. Mounting hinge 132 is configured to resist projectile impacts, deformation, shearing, and pull out from building. Mounting hinge 132 is constructed of any material suitable for withstanding projectile impacts; alternatively, for withstanding explosions and shrapnel. Mounting hinge 132 comprises a metal hinge; alternatively, hinge is any flexible material suitable for pivoting, rotating, of bending action. In instances, mounting hinge 132 is arranged vertically, such that hinge 130 folds vertically. Panel system 100 oriented thusly, may comprise a ballistic door, a gate, or the like without limitation. In this alternate configuration, storage member 150 is an optional component of the panel system. Alternatively, storage member 150 comprises a shuttered compartment, such that the folded panel assembly 109 appears to be a shutter or other exterior aesthetic feature, without limitation.

In certain instances, a plurality of panel system 100 as disclosed herein may be deployed across an opening 102 of building 101. A shaft, pole, or other interlocking member may be configured to interlock panels. Without limitation, a plurality of panel systems 100 may be deployed to any width W, without limitation. Further, vertical stakes, poles, shafts, and other reinforcements may be installed behind a multiple panel system 100 configuration. Further, securable member 300 may be configured to join panels 110, coupling zones 120, panel systems 100, or combinations thereof.

We claim:

1. An apparatus for protecting a building, comprising,
a panel, having a first end and a second end;
a hinge, coupled to the first end of the panel; and
at least one attachment means.

2. The apparatus of claim 1, wherein the panel comprises a ballistic panel.

3. The apparatus of claim 2, wherein the ballistic panel comprises at least one chosen from a metal, an alloy, a ceramic, a polymer, a composite, a fabric, and combinations thereof.

4. The apparatus of claim 3 wherein the ballistic panel further comprises a reinforcement layer.

5. The apparatus of claim 1, wherein a hinge comprises a pivotable means for mounting the panel on a building.

6. The apparatus of claim 1, wherein at least one attachment means comprises a means to reversibly secure the second end of the panel to the building.

7. The apparatus of claim 6, wherein the attachment means comprises,
a first shaft, having a first end and a second end, the first end configured for passing through the panel, into the building;
a second shaft, configured for coupling the first shaft; and
a securing means, for reversibly securing the second shaft to the first shaft from the inside of the building.

8. The apparatus of claim 7, wherein the first shaft second end comprises, a generally planar retainer configured for holding the panel adjacent the building.

9. An apparatus for protecting a building opening, comprising,
a first panel, having a first end and a second end, pivotably coupled to the building at the first end;
at least one second panel, having a first end and a second end;
a first hinge, coupled to the second end of the first panel and the first end of the at least one second panel, configured for folding the first panel parallel to the second panel; and
at least one attachment means.

10. The apparatus of claim 9, wherein the first panel further comprises,
a coupling zone disposed at the second end; and
a hinge reinforcement, coupled to the coupling zone, configured to extend from
the second end of the first panel across the hinge and contact the second panel.

11. The apparatus of claim 10, wherein the second panel further comprises,
a coupling zone disposed at the first end and the second end of the second panel;
a hinge reinforcement, coupled to the coupling zone at the first end of the second panel configured to extend from the first end of the second panel across the hinge and contact the first panel coupling zone; and
a securing means disposed at the coupling zone at the second end.

12. The apparatus of claim 11, wherein the hinge reinforcement of the first panel contacts the second panel and the hinge reinforcement of the second panel contacts the second panel when the hinge is open to about 180 degrees.

13. The apparatus of claim 12, further comprising a hinge reinforcement of the first panel configured for pivotal removal from contact with the second panel, and a hinge reinforcement of the second panel configured for pivotal removal from contact with the first panel, in order to fold the hinge beyond about 180 degrees.

14. The apparatus of claim 9, wherein the attachment means comprises,
a first shaft, having a first end and a second end, the first end configured for passing through the panel, into the building and the second end comprises, a generally planar retainer configured for holding the panel adjacent the building.;
a second shaft, configured for coupling the first shaft; and
a securing means, for reversibly securing the second shaft to the first shaft from the inside of the building.

15. The apparatus of claim 9, further comprising,
a storage member, configured for storing the first panel parallel to the second panel the panel on a building; and
a retainer, coupled to the storage member for retaining the panel.

16. The apparatus of claim 16, wherein the storage member is mounted on the building adjacent to the building opening.

17. The apparatus of claim 16, wherein the storage member comprises building feature chosen from an awning, an overhang, an eve, a roofline, a box, a cavity, a locker, a decorative trim, a planter, a shutter, or combinations thereof.

18. A method of securing a building opening, comprising,
removing a retainer from a storage member containing a at least two panels, pivotably coupled by a hinge having a reinforcement disposed behind the hinge;
pivotably removing a free end of a first panel from the storage member wherein the second panel follows the first panel;
extending the at least two panels, to form a planar structure covering the building opening, wherein the hinge extends to about 180 degrees;
securing the at least two panels to the building opening by a reversible coupling means.

19. The method of claim 18, wherein securing the at least two panels further comprises:
passing a reversible coupling means partially through a passage disposed on the free end of the first panel,
inserting a portion of the reversible coupling means into a receptor, the receptor disposed in the building adjacent the building opening; and
coupling a securing means to the reversible coupling means from the interior of the building, wherein the securing means retains the at least two panels against the building opening.

20. The method of claim 18, wherein securing the at least two panels comprises resisting penetrators chosen from wind, rain, projectiles, explosives, shrapnel, and combinations thereof.
